(19) United States
(12) Patent Application Publication
(10) Pub. No.: US 2010/0142377 A1
(43) Pub. Date: Jun. 10, 2010

(54) SIP Information Extraction

(76) Inventors: Razvan Caciula, Bucharest (RO); Dragos Cantemir, Bucharest (RO)

Correspondence Address: SoCAL IP LAW GROUP LLP, 310 N. WESTLAKE BLVD. STE 120, WESTLAKE VILLAGE, CA, 91362, US

(21) Appl. No.: 12/332,041

(22) Filed: Dec. 10, 2008

(51) Int. Cl. H04L 12/26

(52) U.S. Cl. 370/241; 715/764

(57) ABSTRACT

SIP information extraction is disclosed. A method includes receiving a user selection to create a test involving the Session Initiation Protocol (SIP). Test information is received from the user, including a user selection to extract data included in SIP messages. A user interface guiding a user in specifying SIP data extraction instructions is provided, including receiving source selection instructions, data selection instructions, and data refinement instructions from the user. A test is then executed involving SIP messages. The test includes applying the SIP data extraction instructions to obtain extracted refined SIP message data and using the extracted refined SIP message data to create test SIP messages that include the extracted refined SIP message data or verify if the extracted data conforms to SIP standards or specialized implementations. The method may be implemented in software and performed on one or more network cards and in one or more network testing systems, and may be implemented by one or more computing devices.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND

1. Field

This disclosure relates to network communications, network device testing, network testing, and network traffic analysis.

2. Related Art

Networks such as the Internet carry a variety of data communicated using and through a variety of network devices including servers, routers, hubs, switches, and other devices. Before placing a network into use, the network, including the network devices, network media, network segments and network applications included therein, may be tested to ensure successful operation. Network devices and applications may be tested, for example, to ensure that they function as intended, comply with supported protocols, and can withstand anticipated traffic demands. Such testing may also be performed on already deployed network devices, network segments and network applications.

To assist with the construction, installation and maintenance of networks, network applications and network devices, networks may be augmented with network analyzing devices, network conformance systems, network monitoring devices, and network traffic generators, all which are referred to herein as network testing systems. The network testing systems may allow for analyzing the performance of networks, network applications and network devices by capturing, modifying, analyzing and/or sending network communications. The network testing systems may be used to evaluate how well a network device or network segment handles streaming media and voice communications. A network testing system may allow a user to choose to simulate one or more entities defined by the Session Initiation Protocol (SIP), to simulate real-world VoIP traffic and/or to assess conformance with SIP standards or vendor specified extensions to the SIP standards.

### DESCRIPTION OF THE DRAWINGS

FIG. 1 is a block diagram of an environment in which SIP traffic may be generated, emulated, captured and/or characterized.

FIG. 2 is a flow chart of actions taken to process and extract SIP information from SIP messages.

FIG. 3 is a screen shot of a network testing software user interface.

FIG. 4 is a screen shot of a first SIP extract variables user interface window.

FIG. 5 is a screen shot of a second SIP extract variables user interface window.

FIG. 6 is a screen shot of a third SIP extract variables user interface window.

### DETAILED DESCRIPTION

Throughout this description, the embodiments and examples shown should be considered as exemplars, rather than limitations on the apparatus and methods described.

A System

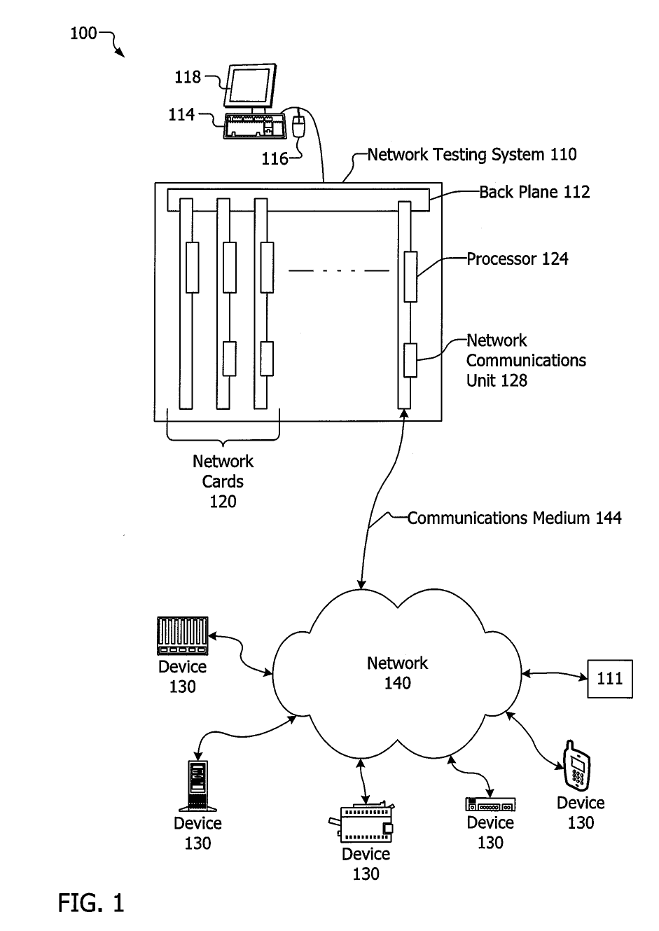

FIG. 1 is a block diagram of an environment 100 in which SIP traffic may be generated, emulated, captured and/or characterized. The environment 100 shows a network testing system 110 in which methods for SIP device emulation and traffic generation described herein may be implemented. The environment 100 includes network testing system 110 coupled via a network card 120 to a network 140 over a communications medium 144. The network testing system 110 may include or be one or more of a performance analyzer, a conformance validation system, a network analyzer, a packet blaster, a network management system, a combination of these, and/or others. The network testing system 110 may be used to evaluate or measure characteristics and performance of a network communication medium, a network communications device or system, including the throughput of network traffic, the number of dropped packets, jitter, packet delay, and many others. Such testing may be used to evaluate the Mean Opinion Score (MOS) or R-value score of a voice transmission, a video quality score or rating, a broadband quality score, or other similar media transmission score for a communication over a network or portion thereof and/or through a network communications device. The network testing system may be used to evaluate the performance of servers, network communications devices such as, for example, routers, gateways, firewalls, load balancers, and other network devices, as well as network applications and other software. The network testing system may be used to verify the functionality of network devices and/or conformance of SIP traffic with SIP standards or with vendor or specialized implementations.

The network testing system 110 may be in the form of a chassis or card rack, as shown in FIG. 1, or may be an integrated unit. Alternatively, the network testing system may comprise a number of separate units such as two or more chassis cooperating to provide network analysis, network conformance testing, and other tasks. The chassis of the network testing system 110 may include one or more network cards 120 and a back plane 112. The network cards 120 may be coupled with back plane 112. One or more network cards 120 may be included in network testing system 110. The network cards 120 may be permanently installed in the network testing system 110, may be removable, or may be a combination thereof.

The network testing system 110 and/or one or more of the network cards 120 may include an operating system such as, for example, versions of Linux, Unix and Microsoft Windows.

Network card 120 is coupled with network 140 via a communications medium 144. Although two connections over communications medium 144 are shown, each of the network cards 120 may be connected with network 140 over a communications medium. In one embodiment, the network cards may have two or more connections each over a communications medium with the network 140 and/or with multiple networks. The communications medium may be, for example, wire lines such as an Ethernet cable, fibre optic cable, and coaxial cable, and may be wireless.

The network testing system 110 and the network cards 120 may support one or more well known higher level (OSI Layers 3-7) communications standards or protocols such as, for example, one or more versions of the User Datagram Protocol (UDP), Transmission Control Protocol (TCP), Internet Protocol (IP), Internet Control Message Protocol (ICMP), Internet Group Management Protocol (IGMP), Stream Control Transmission Protocol (SCTP), Session Initiation Protocol (SIP), Hypertext Transfer Protocol (HTTP), Address Resolution Protocol (ARP), Reverse Address Resolution Protocol (RARP), File Transfer Protocol (FTP), Real-time Transport Protocol (RTP), Real-time Transport Control Protocol (RTCP), Real-Time Streaming Protocol (RTSP), the Media Gateway Control Protocol (MEGACO), Session Description Protocol (SDP), Simple Mail Transfer Protocol (SMTP); may support one or more well known lower level communications standards or protocols (OSI Layers 1-2) such as, for example, the 10 and/or 40 Gigabit Ethernet standards, the Fibre Channel standards, one or more varieties of the IEEE 802 Ethernet standards, Asynchronous Transfer Mode (ATM), X.25, Integrated Services Digital Network (ISDN), token ring, frame relay, Point to Point Protocol (PPP), Fiber Distributed Data Interface (FDDI), Universal Serial Bus (USB), IEEE 1394 (also known as i.link® and Firewire®); may support proprietary protocols; and may support other protocols. Each network card 120 may support a single communications protocol, may support a number of related protocols, or may support a number or combination of unrelated protocols.

The term “network card” as used herein encompasses line cards, test cards, analysis cards, network line cards, load modules, interface cards, network interface cards, data interface cards, packet engine cards, service cards, smart cards, switch cards, relay access cards, CPU cards, port cards, and others. The network cards 120 may be referred to as blades, particularly when a processor is included on the network card.

The network cards 120 may include one or more processors 124 and one or more network communications units 128. In another embodiment, the network cards 120 may have no processors 124 and may include one or more network communications units 128. In the embodiment in which the network cards do not include a processor, processing may be performed by a processor on a motherboard of the network testing system 110, on another card, on the backplane or by a remote or external unit. When the network card 120 includes two or more network communications units 128, the network card 120 is in effect two or more network capable devices. That is, a network card 120 having n network communications units 128 may function as n network capable devices.

The network communications unit 128 may be implemented as one or more field programmable gate arrays (FPGA), application specific integrated circuits (ASIC), programmable logic devices (PLD), programmable logic arrays (PLA), other kinds of devices, and combinations of these. The network communications unit 128 may support one or more communications protocols. The network communications unit 128 may include a network interface through which the network card 120 may transmit and/or receive communications over the network 140.

The network card 120 may include and/or have access to local and/or remote memory, storage media and storage devices. Instructions to be executed by the processor may be stored on and executed from a local or remote machine readable medium or storage device. A machine readable medium includes, for example, without limitation, magnetic media (e.g., hard disks, tape, floppy disks), optical media (e.g., CD, DVD), flash memory products (e.g., memory stick, compact flash and others), and volatile and non-volatile silicon memory products (e.g., random access memory (RAM), programmable read-only memory (PROM), electronically erasable programmable read-only memory (EEPROM), and others). A storage device is a device that allows for the reading from and/or writing to a machine readable medium. Storage devices include hard disk drives, solid-state drives (SSDs), DVD drives, flash memory devices, and others.

The processor 124, network communications unit 128, and memory may be included in one or more FPGAs, PLAs, PLDs on the network card 120. Additional and fewer units, hardware and firmware may be included in the network card 120.

The back plane 112 may serve as a bus or communications medium for the network cards 120. The back plane 112 may also provide power to the network cards 120.

The network testing system 110 may have a computer (not shown) coupled thereto. The computer may be local to or remote from the network testing system 110. The network testing system 110 may have coupled therewith a display 118 and user input devices such as a keyboard 114 and a mouse 116, as well as other user input devices including, for example, pens and trackballs. The user input devices may be coupled to a network card, other card, motherboard, or backplane included in the chassis.

The network testing system 110 may be implemented in a computer such as a personal computer, server, or workstation, as well as the chassis shown. The network testing system 110 may be used alone or in conjunction with one or more other network testing systems 110. The network testing system 110 may be located physically adjacent to and/or remote to the network capable devices 130 in the network 140. The network testing system 110 may be used to test and evaluate the network 140 and/or portions thereof, network capable devices 130, applications running on network capable devices 130, and/or services provided by network 140 and/or network capable devices 130 and/or network applications. The network testing system 110, the network cards 120, and the network communications units 128 may all be network capable devices.

The network 140 may be a local area network (LAN), a wide area network (WAN), a storage area network (SAN), or a combination of these. The network 140 may be wired, wireless, or a combination of these. The network 140 may include or be the Internet. The network 140 may be public or private, may be a segregated test network, and may be a combination of these. The network 140 may be comprised of a single or numerous nodes providing numerous physical and logical paths for data units to travel. Each node may be a network capable device as described below. A node may be a computing device, a data communications device, a network capable device, a network card, or other devices as defined and described herein.

Communications on the network 140 may take various forms, including frames, cells, datagrams, packets, messages, higher level logical groupings, or other units of information, all of which are referred to herein as data units. Those data units that are communicated over a network are referred to herein as network traffic. The network traffic may include data units that represent electronic mail messages, streaming media such as music (audio) and video, telephone (voice) conversations, web pages, graphics, documents, and others.

The network capable devices 130 may be devices capable of communicating over the network 140 and/or listening to, injecting, delaying, dropping, relaying, processing, and/or modifying network traffic on network 140. The network capable devices 130 may be computing devices such as computer workstations, personal computers, servers, portable computers, set-top boxes, video game systems, personal video recorders, telephones, personal digital assistants (PDAs), computing tablets, and the like; peripheral devices such as printers, scanners, facsimile machines and the like; network capable storage devices including disk drives such as network attached storage (NAS) and SAN devices; testing equipment such as network analyzing devices, network conformance systems, emulation systems, network monitoring devices, and network traffic generators; components such as processors, network cards and network communications units; and networking devices such as routers, relays, firewalls, hubs, switches, bridges, traffic accelerators, and multiplexers. In addition, the network capable devices 130 may include appliances such as refrigerators, washing machines, and the like as well as residential or commercial heating, ventilation, and air conditioning (HVAC) systems, alarm systems, and other devices or systems capable of communicating over a network. One or more of the network capable devices 130 may be devices to be tested and may be referred to as devices under test.

The network testing system 110 may send communications over the network 140 to a or through a network capable device 130. The destination of communications sent by the network testing system 110 may be a device under test such as a network capable device 130, may be the network testing system 110, and may be a second network testing system 111. The network testing system 111 may be similar to or the same as network testing system 110. A first network card 120 in the network testing system 110 may send communications over the network 140 to a or through a network capable device 130 that are received by a second network card 120 in the network testing system 110 or are received by a third network card in the network testing system 111. The network testing system 110 may listen to and capture communications on the network 140.

The Methods

The methods described herein may be implemented in various environments, such as environment 100 shown in FIG. 1. Referring to FIG. 1, to perform various tests, network testing software running on the network testing system 110 may send data units from a first network card 120 to a second network card through an intermediary network communications device such as a switch, a firewall, a Session Border Controller (SBC), a gateway, an Application Layer Gateway (ALG), a router such as, for example, a Network Address Translation (NAT) router, an intermediary server or other network capable device 130 over network 140.

As shown in FIG. 1, to perform various tests, network testing software running on the first network testing system 110 may send data units to a second network testing system 111 through an intermediary network communications device 130 such as a router, gateway, switch, intermediary server or other network communications device over network 140.

The methods described herein may be implemented on one or more FPGAs and/or other hardware devices, such as, for example, digital logic devices. The methods described herein may be implemented as software, namely network testing software, running on a network testing system and executed by a processor, such as a processor on a network card or a processor in a blade or other card with a processor in the network testing system. The network testing software may be stored on a volatile or nonvolatile memory device or storage medium included in or on and/or coupled with a computing device, a network testing system, a network card, or other card. The methods may be implemented on one or more network cards 120 in a single network testing system or may be implemented on one or more network cards 120 on each of and between two network testing systems 110 and 111.

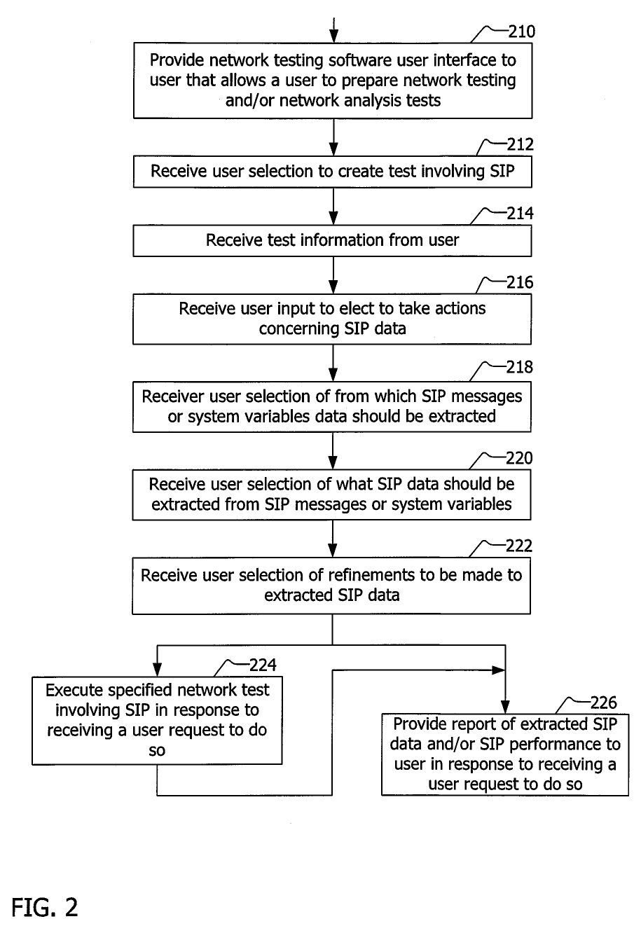

FIG. 2 is a flow chart of actions taken to process and extract information included in SIP messages sent, received and/or captured by the network testing system. The actions described may be performed by network testing software or other software executing on a network testing system or other computing device. The network testing software provides a network testing software user interface to user that allows a user to prepare network testing and/or network analysis tests, as shown in block 210. The user interface may use a variety of user interface elements, including, but not limited to, windows, panes, frames, buttons, sliders, menus, text entry fields, radio buttons, check boxes, etc.

The network testing software on a network testing system provides a user interface to receive network tests specified by a user. The network tests typically include sending or transmitting network traffic, and receiving network traffic that conform to one or more network communications protocols. Pertinent to the discussion herein are network tests involving SIP, which may include SDP, RTP and related protocols, features and services.

Specifically, the methods described herein are for extracting information from data units that conform to the SIP standard, Internet Engineering Task Force (IETF) Request For Comments (RFC) 3261 (J. Rosenberg et al., June 2002) and related IETF RFC documents, such as RFC 3891, RFC 3911, and others. These RFCs are collectively referred to herein at the SIP standards. For testing and evaluating a network, network devices or network applications, the network testing software may emulate one or more SIP clients (e.g., SIP User Agents), one or more SIP servers (e.g., SIP Proxy Servers), or a cloud composed from different SIP entities. The network testing software may also generate negative or nonconforming SIP or other traffic to test application or device conformance with the SIP standards or other related standard. The SIP client may simulate a caller with a softphone establishing sessions with another softphone-equipped callee. A softphone as used herein refers to software that emulates a telephone, either land line or cellular, or software that conforms to the SIP standards. The SIP clients may be registered to a simulated or a real SIP server. The network testing software may provide the simulated SIP server. The SIP clients may simulate media traffic between a telephone caller and callee by playing audio and/or video files over the SIP session established between them. To transport the audio, the SIP clients may use RTP. To transport other streams between two SIP nodes such as streaming media, video, multimedia, and for controlling sessions, the SIP client and server may use RTP, RTCP, SDP, and other protocols. The network testing system software may include functionality that allows a user to perform various tests and analyses involving SIP message exchange, including, for example: registration capacity and performance; call setup and teardown capacity and performance; redirection performance; SIP conformance with standards or with vendor or specialized implementations; and network performance.

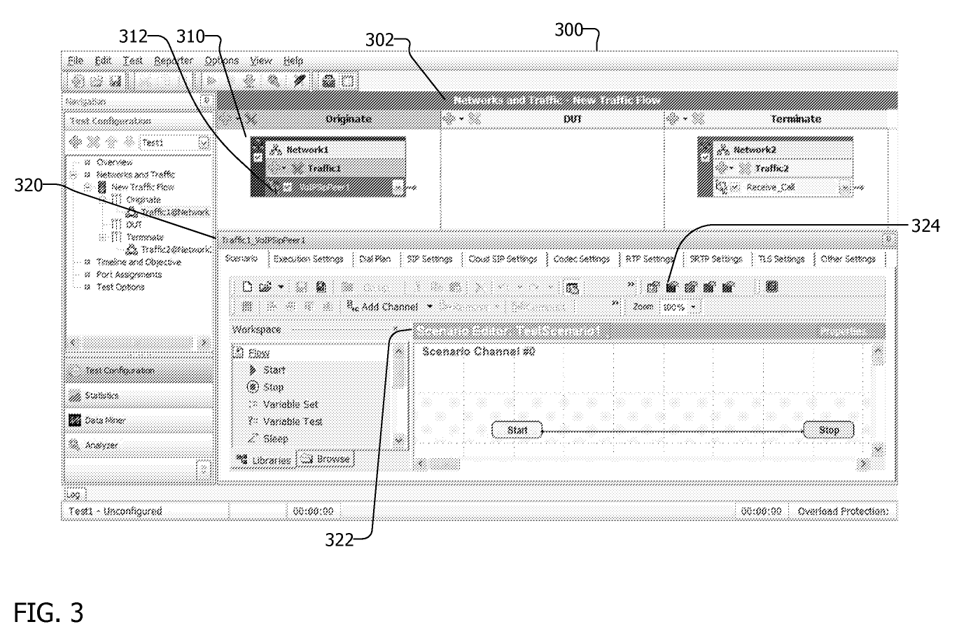

FIG. 3 is a screen shot of an example network testing software user interface. In this example, the network testing software has a main window 300, and a varying number of sub-windows or panes depending on the action taken and elements selected. The network testing system software user interface may allow a user to configure SIP clients, including softphones, and SIP servers and may allow a user to specify a multitude of test, including SIP performance and conformance testing that may include negative SIP testing through the generating of nonconforming SIP messages.

As shown, the main window includes a pane that shows the networks and traffic 302 of a current test configuration. The originator of network traffic is shown in pane 302 as network in graphical element 310. Further details about various characteristics of the testing to be performed and data units to be sent may be specified via the user interface. The network testing software provides a user interface that may include a menu selection item that allows a user to select from multiple kinds of simulated entities and/or communications protocols. Pertinent to this patent are VOIP, especially SIP, entities and protocols assigned to the originating node 310, in this example named Traffic1. The network testing software may allow for selection of various VOIP, SIP and similar traffic elements. This may be achieved with well known user interface techniques, including, in this example, a menu or a drop-down combo box. The menu may include, for example, SIP client, SIP server, VOIP/SIP peer, VOIP/SIP cloud, and others. As shown in this example, the VoIPSipPeer1element 312 is selected from the menu. Clicking on element 312 allows the user to view the configuration for the selected VOIP/SIP traffic element. In response to receiving a user's click on element 312, the network testing software provides a user interface that presents the configuration information for element 312 in another pane 320 labeled, in this example, Traffic1_VoIPSipPeer1. Further details about the VoIPSipPeer1 actions may be provided in scenario test editor pane 322 included in pane 320.

Returning now to a discussion of the method shown in FIG. 2, the network testing software receives a user selection to create a test involving SIP, as shown in block 212. This corresponds to a user selecting a VOIP/SIP traffic element from the menu associated with element 312 in FIG. 3. In one embodiment, each traffic flow element has an associated test, that is, a description of the message flow together with control information and statements, including, for example, loops, conditional statements and the like. The network testing software receives test information from the user, as shown in block 214. The network testing software receives user input to elect to take actions concerning SIP data, as shown in block 216. These actions correspond to a user clicking on element 312 in FIG. 3 and adding additional information via scenario editor 322 and associated other actions made available in the user interface provided therewith, shown in FIG. 3. The user input received by the user interface of the network testing software may include clicking on an icon such as icon 324 in FIG. 3, selecting a button, making a selection from a menu, using mouse drag and drop, and other user interface techniques. One of the actions available to the user provided by user interface of the network testing software is the user selection of source, that is from which SIP messages or test variables data should be extracted to be used to perform further tests or to perform stream or network traffic analysis.

The network testing software receives user selection of from which SIP messages or test variables data should be extracted, as shown in block 218. The test variables may contain an entire SIP message or a part of it. The test variables may be user defined. The test variables may be used to store the extracted SIP data or other SIP message information. The actions described in block 218 may be referred to as receiving SIP data source selection instructions. The SIP data source selection instructions may include a condition in the form of an expression that must be met for data extraction to be performed. That is, the network testing system may evaluate whether a user specified condition or expression, is satisfied or met before extracting information from a SIP test variable or SIP message. Also the success or failure of the SIP information extraction operation may depend on the occurrence of prior activity, such as, for example, prior to entering the current function block an SIP message was sent or received or another function block directly or indirectly set the value of a specific variable. The network testing software may provide a user interface to ease and automate the user's selection of an SIP data source, that is, an SIP message or test variable from which data should be extracted.

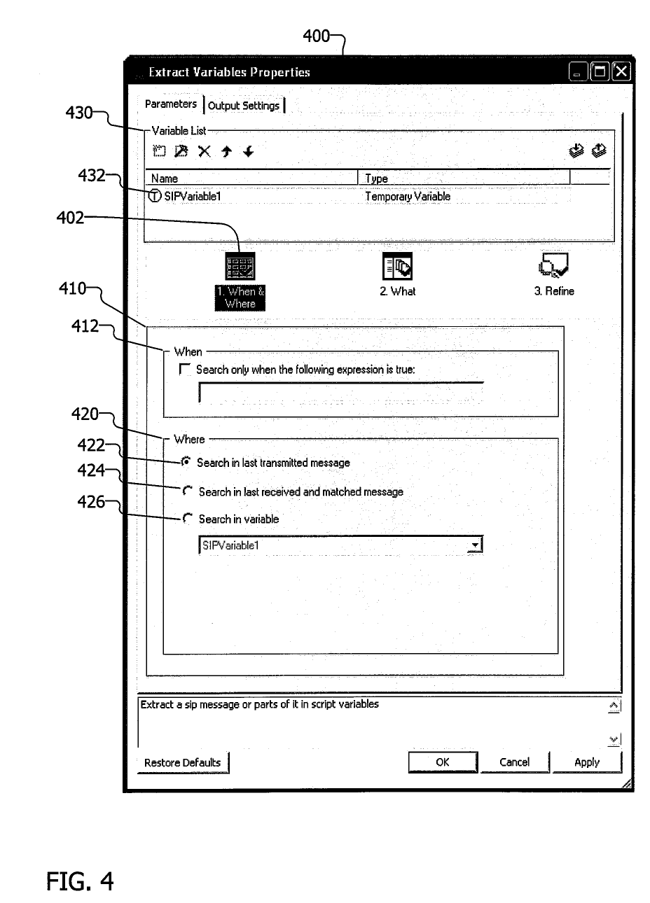

FIGS. 4, 5 and 6 are screen shots of SIP extract variables user interface windows that guide a user in specifying the SIP data extraction instructions. The SIP data extraction instructions include SIP data source selection instructions. The SIP data source selection instructions include a user specification of under what conditions SIP data is to be extracted, from which source data should be extracted. The SIP data extraction instructions also include specification of what part or parts of the specified SIP message or test variable should be extracted. The SIP data extraction instructions may also include additional operations to be performed on extracted substrings and where to save the obtained data. Extracted data may be stored to a temporary variable to be used locally for multiple extractions or a test variable that may be used to construct further SIP messages, prepare SIP or other performance reports, or evaluate SIP or other conformance by comparing the value with expected values or ranges.

Referring now to FIG. 4, SIP extract variables user interface window 400 allows a user to provide SIP data source selection instructions. To begin user specification of the SIP data source selection instructions, the network testing software recognizes user selection of a temporary or a test variable 432 from within the variable list box 430. In this example, the variables are presented in a text pane having a “name” and a “type” column within the variable list box 430. The test variable 432 shown in this example has as its name “SIPVariable1” and its type is “Temporary Variable”. The network testing software may provide additional user interface elements to allow a user to add new systems variables, edit test variables, delete test variables, and reorder the list of test variables. For example, the additional features may be provided by the network testing software displaying a menu when a user right clicks on the “Variable List” heading. Or this may be achieved by adding buttons to the top portion of the “variable list” box 430, as shown. In one embodiment, the order in the list is important as it defines the sequence in which the extraction will occur. That is, the first test variable together with its associated extraction rules is processed first, followed by the second test variable and its associated rules, and so on. The extraction of data into test variables may be conditioned by an expression specified in the “when” box 412. The data extracted according to a current test variable may be based on the value of an earlier extracted and stored test variable. The filling of dependent test variables may be performed in a similar manner or may be accomplished through other techniques—for example, a specific implementation of the network testing system may choose to always fill in some predefined test variables using parts of sent/received SIP messages.

The network testing software then recognizes user selection of the “when and where” icon 402. The user selecting “when and where” icon 402 causes the network testing software to display “when” box 412 and “where” box 420 within “when and where” box 410. Selection box 412 labeled “when” allows a user to specify that data from an SIP message or test variable will be extracted only when a user specified expression is true or is met. An example expression is value matching, such as, someVariable==someValue, or, for example MySIPVariable1==“abc”. In this example, data is extracted only when the value of the user-defined variable named MySIPVariable1 is the string “abc”. Another example may be to extract data only when a specified variable has an even or odd value. For example, the expression someVariable 2*(someVariable/2) will cause data to be extracted only when the predefined integer variable some Variable is even.

Selection box 420 labeled “where” allows a user to select which SIP message should be examined in order to extract specified data. In one embodiment, the network testing software allows a user to select that the user specified variable should be filled in with data extracted from one of: [a] the last transmitted SIP message 422, [b] the last received and matched SIP message 424, that is, the last SIP message received by the simulated SIP entity that matched an expected SIP message template (specified prior to entering the Extract Variables selection area), and [c] the value of a user specified variable 426. The specified variable to search in 426 may be selected from a menu provided by the network testing software. Example variables include predefined test variables, examples of which include SIP_Message, SIP_Call ID, SIP_Contact, SIP_From, SIP_To, SIP_Via, SIP_Route. The network testing software may populate a drop-down list with existing predefined or user-defined test variables. The variable list may also include temporary or test variables defined earlier by the user as describe above regarding box 430.

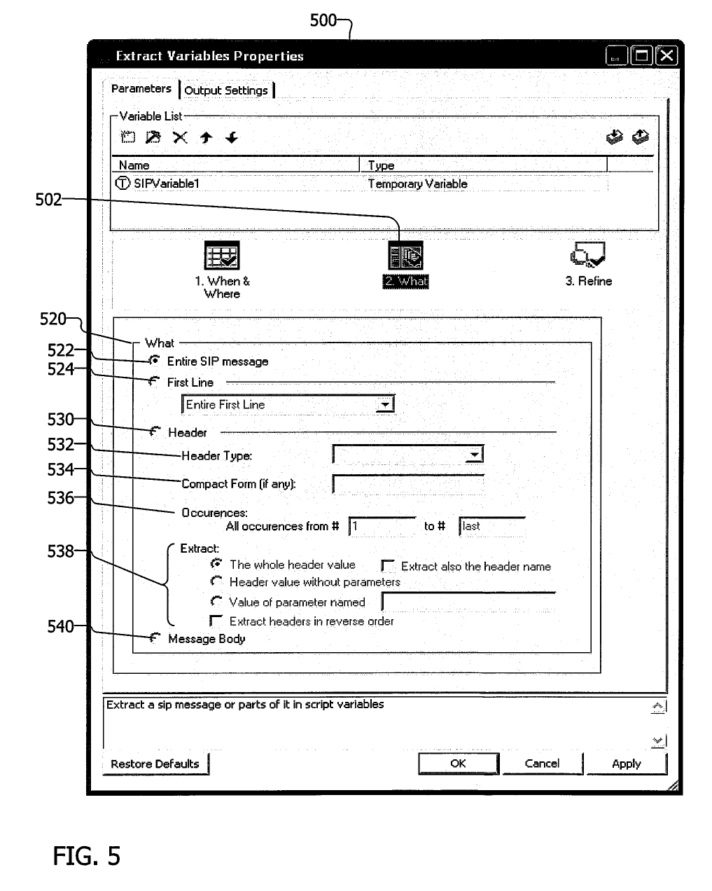

Returning now to a discussion of the method shown in FIG. 2, the network testing software receives user selection of what SIP data should be extracted from SIP messages or test variables, as shown in block 220. The actions in block 220 may be referred to as receiving data selection instructions. The network testing software may provide a second SIP extract variables user interface window 500 shown in FIG. 5 to guide a user in providing the data selection instructions. FIG. 5 is a screen shot of a second SIP extract variables user interface window 500. In this window, when the “what” icon 502 is, selected by a user, a corresponding “what” data entry box 520 is displayed. The “what” data entry box 520 allows a user to specify from what portion of an SIP message data should be extracted. The network testing software may allow a user to select to extract the entire SIP message, as shown in block 522 labeled “Entire SIP message”. A user specified part of the first line or the entire first line of an SIP message may be extracted, as shown in field 524. More specifically, data may be extracted from the first line of an SIP request message (such as, for example, Request Line—Method, Request Line—Request-URI, Request Line—SIP Version;) or from the first line of an SIP response message, (such as, for example, Status Line—SIP Version, Status Line—Status-Code, Status Line—Reason Phrase).

The network testing software may allow a user to select to extract data from a header included in an SIP message, as shown in block 530. SIP messages may include multiple headers with multiple header types as set forth in the SIP standards. Also a specific header may appear multiple times within the same SIP message, each time having different values. The network testing software may allow a user to select a header type via a menu 532. Header types may include, for example, Also, Authorization, Call-ID, Contact, Content-Length, Content-Type, Event, Expires, From, Route, To and others based on typical SIP header types as described by RFC 3261, by other related IETF RFC documents, or by proprietary extensions to the SIP standards. The network testing software may allow a user to select the compact form of the header 534. In one embodiment, the network testing software may accept user specified custom headers. In one embodiment, when the header 530 is selected, the network testing software automatically fills in the compact form field 534 with the header's compact form when such a form is defined and understood by the network testing system.

The network testing software may allow a user to extract data from multiple occurrences of a specific SIP header as shown in occurrences element 536. The network testing software may allow a user to set a range of occurrences 536 to be extracted for the specified header type 532. When the occurrence count is greater than one, the specified number of headers are processed, and data is extracted according to further specified rules.

The network testing software may provide additional header extraction options 538. An additional header extraction option 538 includes allowing a user to specify extraction of a whole header value, except for the header name. Another additional header extraction option 538 includes allowing a user to specify extraction of the whole header, including the header name. The selection of extracting a whole header including or excluding a header name may be achieved via a menu, check boxes or the user interface technique. An additional header extraction option 538 includes allowing a user to specify extraction of header values without any parameters. In one embodiment, this option is available only for occurrence counts equal to one. Another header extraction option 538 includes allowing a user to specify the value of user specified parameter. In this example, the network testing software extracts the value of the user specified parameter. In one embodiment, this option is available only for occurrence counts equal to one. Another header extraction option 538 includes allowing a user to extract headers in reverse order. According to this option, in this embodiment, when the resulting occurrence count is greater than one, this option causes the network testing software to process the header occurrences in reverse order, starting from the last until the first header is reached.

Further, the network testing software may allow a user to specify that data should be extracted from the message body of an SIP message, as shown by item 540. The message body may include or be an SDP specification, an XML string, or other body content as specified in the Content-Type header of the SIP message.

Returning now to a discussion of the method shown in FIG. 2, the network testing software receives a user selection of refinements to be made to extracted SIP data, as shown in block 222. The actions described in block 222 may be referred to as receiving the data refinement instructions. After a data source is selected for data extraction according to the data source selection instructions (discussed above regarding FIG. 4), and after SIP data selected and extracted according to the data selection instructions (discussed above regarding FIG. 5), the extracted SIP data may be refined according to the data refinement instructions. The refining causes the network testing software to process the extracted data as specified by the user and to prepare extracted refined SIP message data.

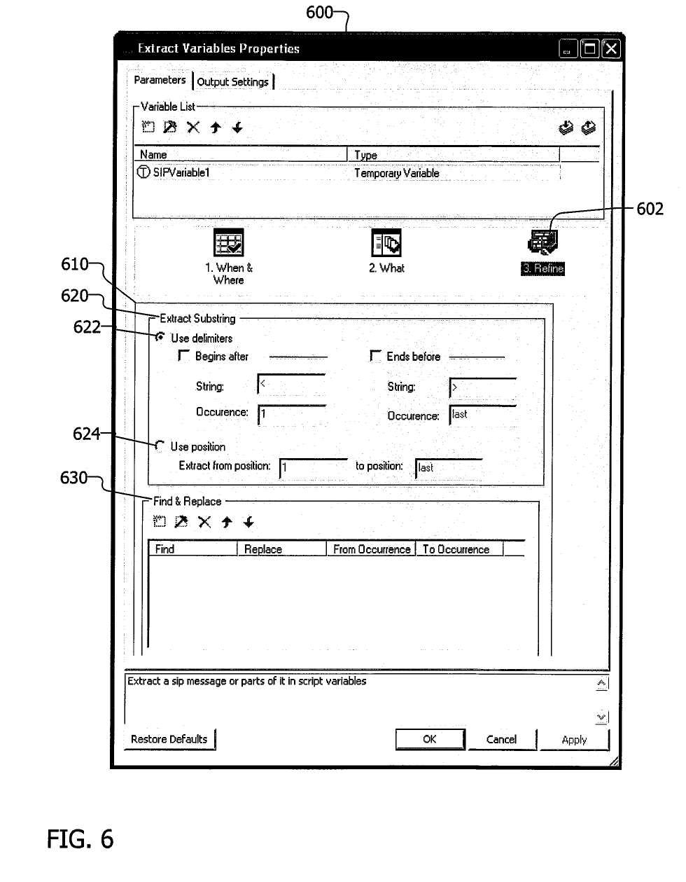

FIG. 6 is a screen shot of a third SIP extract variables user interface window 600 that directs a user to provide data refinement instructions. The third SIP extract variables user interface window 600 shows the user interface the network testing software provides when a user selects refine icon 602. Selecting the refine icon 602 causes the network testing software to display a refine data entry box 610. In one embodiment, in the refine data entry box 610, the network testing software provides an extract substring box 620 which gives a user the ability to extract substrings according to user specified delimiters 622 or based on user specified positions 624. To achieve this functionality, the network testing software may provide an extract substring box 620 with buttons or other user interface items that allow a user to select between a “use delimiters” button 622 and a “use position” button 624.

When the “use delimiters” button 622 is selected, the network testing software allows the user to further specify that a substring should be extracted between two user specified delimiters 622. The delimiters 622 include a start string, the “begins after” string, and an end string, the “ends before” string, as shown in FIG. 6. These strings, the “begins after” string and the “ends before” string, may each be single characters or multiple characters, and they may be the same or different characters as specified by the user. The network testing software may also allow a user to specify the number of occurrences of the delimiters. For example, if both the “begins after” string and the “ends before parameter” string are each a semicolon “;” character, and the “begins after parameter” occurrence value is two and the “ends before parameter” occurrence value is three, the extracted substring would be the substring located between the 2nd and the 3rd occurrence of the semicolon “;” character.

When the “use position” button 624 is selected, the network testing software allows the user to further specify that a substring should be extracted starting at a first value and ending at a second or last value. That is, the substring is extracted from the position identified by the first value up and through the position ending with the second or last value. Specifically, the user interface allows a user to specify refinement of a substring that begins at the “extract from position”, the first value, through the “to position”, the second value. The values may refer, in one embodiment, to character positions, and in other embodiments to bit positions, byte positions, or word positions, the size of a word being 16 bits, 32 bits, 48 bits, 64 bits, 128 bits, and other typically used word sizes.

In addition, the network testing software may include in the refine box 610 a find and replace box 630. The network testing software may provide the user the ability to specify replacement operations on extracted data. Extracted data may be referred to as and is generally a string of alphanumeric characters. The network testing software may provide the user this ability using a variety of user interface techniques and items. The network testing software may provide various iconic buttons and other user interface elements that allow the user to create find and replace rules. The find and replace rules allow a user to specify a first substring and specify a second substring that should be used to replace the first substring. The network testing software may allow a user to specify multiple find and replace rules. The network testing software may allow a user to specify the order in which the find and replace rules should be successively applied to extracted data.

After the network testing software receives the user specified network test involving SIP message exchange including data extraction instructions to extract SIP information from some SIP messages, the network testing software executes the user specified network test involving SIP in response to receiving a user request to do so, as shown in block 224. The network test may include sending and/or receiving SIP messages, extracting information from SIP messages, and sending SIP messages (namely, requests and/or responses) based on the extracted SIP information obtained in the actions performed in blocks 210 through 222. That is, the network testing software may receive a user request to prepare other SIP messages based on extracted SIP information. The network testing software may receive a user request to match other received messages against a message template constructed using the extracted SIP information. The network testing software automates this according to the actions performed in blocks 210 through 222. The network testing software guides a user in providing SIP extract variable instructions by providing a series of three user interface windows shown in FIGS. 4, 5 and 6.

The user interfaces provided by the network testing software and shown in FIGS. 4, 5 and 6 guide a user in providing SIP data extraction instructions including source selection instructions, data selection instructions, and data refinement instructions as described above. After a network test is specified including SIP extract variable instructions, the network testing software executes the user specified network test. During the network test, the network testing software applies the SIP extract variable instructions to obtain extracted refined SIP message data. Additional portions of the network test are then performed which include creating test SIP messages that are based on or include the extracted refined SIP message data. The execution of the network test includes transmitting the test SIP messages that are based on or include the extracted refined SIP message data.

Additionally, the network testing software may use the extracted SIP message data to modify or change the execution or flow of a test. The extracted SIP message data may be used to evaluate the occurrence of a condition such that certain specific actions are taken when SIP message data is found or is successfully extracted and other, different actions are taken when the message data is not found or is not extracted. For example, a first next sequence of actions is taken when a particular header is included in the extracted SIP message data while a second, different sequence of actions is taken when the particular header is not found in the extracted SIP messaged data. In another example, if a particular header value is found in the extracted SIP message data, a first next sequence of actions is taken, while if that value is not found, a second, other next sequence of actions is taken. The value evaluated may be a single value, a range of values, a Boolean expression, a set of values, etc. The extracted SIP message data may be used to evaluate and characterize whether the SIP traffic conforms to the SIP standards and/or specialized vendor implementations. The extracted SIP message data may be used to simulate traffic that an SIP conforming device would produce, that is, to emulate an SIP device.

In addition or in the alternative, the network testing software may provide a report of extracted SIP data and/or SIP performance to a user in response to a user request to do so, as shown in block 226. The reports and information may be based on extracted SIP information obtained by performing the actions described in blocks 210 through 222 and 224. Reports and information concerning SIP performance may include the number of calls initiated, the number of calls established, the number of call active, the number of transactions initiated successfully and/or that failed, the number of and kind of call initiation failures, the number of various kinds of SIP messages sent and/or received by the client, including INVITE, ACK, BYE, and REGISTER, the number of bytes sent and/or received, the number of packets sent and/or received, the average message size, etc. The network testing system may also provide RTP statistics and performance information in response to a user request to do so, including the number of RTP packets sent, dropped, and/or received; information about jitter affecting RTP packets, etc. Stream related statistics may also be maintained and provided by the network testing system, including, the number of packets transmitted, dropped, lost, bad and/or sent in a stream, the MOS for a stream, the minimum, maximum and/or average jitter for a stream, etc. Specific data about the kind of data sent using SIP may also be maintained and provided by the network testing system, including data regarding multimedia, video and/or audio sent via RTP and SIP. Similar statistics regarding SIP and RTP may be maintained and provided for an SIP server.

With regard to the methods described herein, additional and fewer steps may be taken, and the steps as shown may be combined or further refined to achieve the methods described herein.

The described systems and methods may also accommodate other text-based communication protocols such as, for example, Hypertext Transfer Protocol (HTTP), Simple Mail Transfer Protocol (SMTP), POP3, IMAP, and others. To accommodate other text-based communication protocols, the data selection instructions shown in FIG. 5 would be amended to conform to the particular requirements of the text-based communication protocol.

Although exemplary embodiments have been shown and described, it will be apparent to those having ordinary skill in the art that a number of changes, modifications, or alterations to the systems and methods described herein may be made, none of which depart from the spirit and scope of the description provided. All such changes, modifications and alterations should therefore be seen as within the scope of this patent.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, that is, to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method of creating network tests based on extracted information obtained from Session Initiation Protocol (SIP) messages, the method performed by network testing software, the method comprising:
providing a graphical user interface to a user
receiving a user selection to create a test involving Session Initiation Protocol messages
receiving test information from the user
receiving a user selection to extract SIP data
providing an SIP extract variable user interface allowing the user to specify SIP extract data instructions including
source selection instructions
data selection instructions
data refinement instructions
receiving user specification of the SIP extract data instructions including
the source selection instructions
the data selection instructions
the data refinement instructions
executing the test involving SIP messages including applying the SIP extract data instructions to the SIP messages to obtain extracted refined SIP message data
creating test SIP messages that include the extracted refined SIP message data
transmitting the test SIP messages.

2. The method of claim 1 wherein
the source selection instructions specify from which SIP messages or test variables data should be extracted
the data selection instructions specify which data should be extracted from SIP messages or test variables
the data refinement instructions specify refinement action to be performed on extracted SIP data.

3. The method of claim 1 wherein providing the SIP extract variable user interface includes
providing a source selection instruction window including
a first element to receive a variable name in which extracted information will be stored
a second element to receive a user defined expression to serve as a condition for data extraction to be performed
a third element to receive location information including a last transmitted message, a last received and matched message, and a test variable.

4. The method of claim 1 wherein providing the SIP extract variable user interface includes
providing a data selection instruction window including an element allowing a user to select between one from the list including entire message, first line of a message, designated header from the message, and the message body.

5. The method of claim 1 wherein providing the SIP extract variable user interface includes
providing a data refinement instructions window including a substring designation selection area and a substring find and replace configuration area.

6. The method of claim 5 wherein the substring designation selection area allows for specification of either begin and end delimiters or a position.

7. The method of claim 5 wherein the substring find and replace configuration area allows for specification of a first substring to be replaced with a second substring.

8. The method of claim 1 further comprising:
controlling an execution flow of the test based on extracted refined data SIP data.

9. The method of claim 1 further comprising:
designating the test a success or failure based on the extracted refined SIP data.

10. The method of claim 1 further comprising:
receiving a user request to provide an SIP performance report
providing the SIP performance report.

11. A network testing system comprising:
a processor
a plurality of network cards
a storage medium having instructions stored thereon which when executed cause the network testing system to perform actions comprising:
providing a graphical user interface to a user
receiving a user selection to create a test involving Session Initiation Protocol messages
receiving test information from the user
receiving a user selection to extract SIP data
providing an SIP extract variable user interface allowing the user to specify SIP extract data instructions including
source selection instructions
data selection instructions
data refinement instructions
receiving user specification of the SIP extract data instructions including
the source selection instructions
the data selection instructions
the data refinement instructions
executing the test involving SIP messages including applying the SIP extract data instructions to the SIP messages to obtain extracted refined SIP message data
creating test SIP messages that include the extracted refined SIP message data
transmitting the test SIP messages.

12. The system of claim 11 wherein
the source selection instructions specify from which SIP messages or test variables data should be extracted
the data selection instructions specify which data should be extracted from SIP messages or test variables
the data refinement instructions specify refinement action to be performed on extracted SIP data.

13. The system of claim 11 wherein providing the SIP extract variable user interface includes providing a source selection instruction window including
a first element to receive a variable name in which extracted information will be stored
a second element to receive a user defined expression to serve as a condition for data extraction to be performed
a third element to receive location information including a last transmitted message, a last received and matched message, and a test variable.

14. The system of claim 11 wherein providing the SIP extract variable user interface includes
providing a data selection instruction window including an element allowing a user to select between one from the list including entire message, first line of a message, designated header from the message, and the message body.

15. The system of claim 11 wherein providing the SIP extract variable user interface includes
providing a data refinement instructions window including a substring designation selection area and a substring find and replace configuration area.

16. The system of claim 15 wherein the substring designation selection area allows for specification of either begin and end delimiters or a position.

17. The system of claim 15 wherein the substring find and replace configuration area allows for specification of a first substring to be replaced with a second substring.

18. The system of claim 11 wherein the storage medium has further instructions stored thereon which when executed cause the network testing system to perform further actions comprising:
controlling an execution flow of the test based on extracted refined SIP data.

19. The system of claim 11 wherein the storage medium has further instructions stored thereon which when executed cause the network testing system to perform further actions comprising:
designating the test a success or a failure based on the extracted refined SIP data.

20. The system of claim 11 wherein the storage medium has further instructions stored thereon which when executed cause the network testing system to perform further actions comprising:
receiving a user request to provide an SIP performance report
providing the SIP performance report.

21. The system of claim 11 wherein the processor and storage medium are included on a motherboard of the network testing system.

22. The system of claim 11 wherein the processor and storage medium are included in one of the plurality of network cards of the network testing system.

23. The system of claim 11 wherein the network cards each include a second processor, a network communications unit and a second storage medium.
